(19) United States
(12) Patent Application Publication
(10) Pub. No.: US 2014/0122063 A1
(43) Pub. Date: May 1, 2014

(54) METHOD AND SYSTEM FOR ESTIMATING PHYSIOLOGICAL PARAMETERS OF PHONATION

(71) Applicants: Pedro Gomez Vilda, Madrid (ES); Victoria Rodellar Biarge, Madrid (ES); Victor Nieto Lluis, Madrid (ES); Agustin Alvarez Marquina, Madrid (ES); Rafael Martinez Olalla, Madrid (ES)

(72) Inventors: Pedro Gomez Vilda, Madrid (ES); Victoria Rodellar Biarge, Madrid (ES); Victor Nieto Lluis, Madrid (ES); Agustin Alvarez Marquina, Madrid (ES); Rafael Martinez Olalla, Madrid (ES)

(73) Assignee: UNIVERSIDAD POLITECNICA DE MADRID, Madrid (ES)

(21) Appl. No.: 14/127,202

(22) PCT Filed: May 16, 2012
(86) PCT No.: PCT/ES2012/000137

§ 371 Date: Dec. 18, 2013

(30) Foreign Application Priority Data
Jun. 27, 2011 (ES) P201131069

(51) Int. Cl. G10L 19/02

(52) U.S. Cl. CPC G10L 19/02
USPC 704/200.1

(57) ABSTRACT

The invention consists of a method and computing system for recording and analyzing the voice which allows a series of parameters of phonation to be calculated. These transmit relevant information regarding effects caused by organic disorders (which affect the physiology of the larynx) or neurological disorders (which affect the cerebral centers of speech). The classification methods are also considered an essential part of the invention which allow estimations of the existing dysfunction to be obtained and for the allocation of personality. The usefulness of the invention lies in the possibility of applying the dysfunction estimation in primary care service centers for patient screening to specialist care centers, simplifying examination protocols, saving costs and reducing waiting lists. This methodology can also be used for detecting the personality of a speaker by their voice, allowing access to installations or services.

### TECHNICAL SECTOR

The invention belongs to the sector of computer and communication technologies with application in biomedicine and security, and more specifically in the field of detecting and grading the organic pathology of the voice by means of classifying parameters obtained from the glottal wave of the voice and managing secure access by voice.

### BACKGROUND OF THE INVENTION

Measuring the quality of the voice as a method for diagnosing and grading the organic pathology of the voice has experienced a significant boom in the last decade. This has resulted in a group of computer applications which, based on the voice, generate measurement indices of the quality of the voice as variants of jitter (disturbance of the period of phonation over time), of shimmer (temporal disturbance of the amplitude of phonation from cycle to cycle), of the signal to noise ratio (between the periodic part and non periodic part of a voice segment), of the glottal/noise index (proportion between the glottal wave energy with respect to the residual noise present in the voice), and of temporal parameters which reflect the opening and closing processes of the vocal folds during phonation such as the cycles of recovery, closing, opening and closure. The parametric estimation processes are usually carried out via the voice measured at the point of capture of the same, generally a general-purpose microphone in order to be digitalized and post-processed. The normal processes are extraction in the spectral and temporal domain. Among the first processes is determining its power spectral density and based thereon, the mel-cepstrum parameters, their first and second differentials. Using related methods, harmonic energy to noise ratio is also measured. The temporal parameterization part of the reconstruction of the glottal source, via which the duration of the phonation cycle is measured (duration in time between two consecutive closures of the vocal folds), from that recovery, opening and closing times are derived and based thereon, the glottal to noise ratios and the pitches of the glottal pulse are determined.

The basic methodology supporting the invention is the precise estimation of the glottal wave. This is understood as the correlate of sound pressure developed in glottis during phonation. Work in this field began at the beginning of the 90s with contributions from Paavo Alku and his colleagues on the inversion of the speech frames for the reconstruction of the glottal pulse (Alku, P., “Glottal wave analysis with pitch synchronous iterative adaptive inverse filtering”), Speech Communication, vol. 11, 1992, pp. 109-118. With respect to the combined estimation of the glottal wave and the vocal tract, the works of P. Murphy and his team (Akande, O., and Murphy, P. J. “Estimation of the vocal tract transfer function for voiced speech with application to glottal wave analysis”, Speech Communication, Vol. 46, 2005, pp. 15-36) may also be cited. As referenced in the application to the application of parameterization of the glottal wave in the biometric description of the speaker, the classic works of Reynolds and his team should be cited (Reynolds, D. A., Quatieri, T. F., Dunn, R. B., “Speaker Verification Using Adapted Gaussian Mixture Models”, Digital Signal Processing, Vol. 10, 2000, pp. 19-41). A good review of these types of identity verification technologies by means of voice may be found in the classic work by Bimbot et. al. (Bimbot, F., Bonastre, J. F., Fredouille, C., Gravier, G., Magrin, I., Meignier, S., Merlin, T., Ortega, J., Petrovska, D., Reynolds, A., “A Tutorial on Text-Independent Speaker Verification”, EURASIP J. on App. Sig. Proc., Vol. 4, 2004, pp. 430-451).

In the field of dysphonia detection, there are solutions based on the analysis of undifferentiated speech such as the systems:
CSL (Computerized Speech Lab), MDVP (MultiDimensional Voice Program) and APM (Ambulatory Phonation Monitor) from Kay Elemetrics (KayPENTAX), URL: http://www.kayelemetrics.com (20 Apr. 2011)
MEDIVOZ and WPCVox from TGH ENDOSCOPIA, URL: http://www.tghendoscopia.com/ (20 Apr. 2011)
Dr. Speech, URL: http://www.drspeech.com/ (20 Apr. 2011)
SESANE (Software Environment for Speech ANalysis and Evaluation) from SQLab, URL: http://www.sqlab.fr/sesaneUK.htm (20 Apr. 2011)
LingWaves from WEVOSYS, URL: http://www.wevosys.com/ (20 Apr. 2011)
Speech Studio, from Laryngograph. URL: http://www.laryngograph.com/ (20 Apr. 2011)
WaveView Software, from Glottal Enterprises, URL: http://www.glottal.com/
Other applications remotely related to the processing of the voice, since they have been developed for speech treatment are Wavesurfer (URL: http://www.speech.kth.se/wavesurfer/), and Praat (URL: www.praat.org).

These solutions deal with the study of the voice by means of classic acoustic analysis, technologically supposing a prior art to that proposed by the present application. The technology desired to be patented considers the voice as a result of two processes: production of laryngeal excitation or glottal wave in the vocal folds and articulatorily filtered by the vocal tract which is the acoustic area formed by the pharyngeal, nasal and oral cavities. The second of the processes is very variable even for the speaker himself, since it is influenced by the message and is very easily settable. The first of the processes, the production, is less variable for the speaker and difficult to set and obtain information on the neurological, emotional and physiological state of the production device. These features provide the invention proposed in this application with a great advantage in the biometric field in general and in particular in the clinical and forensic fields. For this purpose signal treatment methods and pattern recognition are used which are the basis of the application proposed.

In the field of neuromotor pathology detection of speech a Kiosk system is known for early detection of Alzheimer's disease, even though it is technologically not an advanced product since it is only used to register without involving an acoustic analysis.

In the field of the identification and verification of the speaker and personality allocation, there exist the systems:
VocalPassword and similar, from Persay, URL: http://www.persay.com/ (20 Apr. 2011)
Verifier, from Authentify, URL: http://www.authentify.com/ (20 Apr. 2011)
ASIS, KIVOX, BS and BatVox, from Agnitio, URL: http://www.agnitio.es/ (20 Apr. 2011)
SecuriVox from SpeechSentinel, URL: http://www.speechsentinel.co.uk/ (20 Apr. 2011)
BioVox from DTEC, URL: http://www.dtec-bio.es/ (20 Apr. 2011)

The differential characteristic of the proposed solution with respect to all those systems is based on the use of speech segments which are exclusively phonated, that is to say, they occur with voice production, in the reconstruction of a phonation correlate intimately linked to the biomechanics of phonation, and in the parameterization of said correlate in the biomechanical and biometric fields by means of reconstructing the production system more approximately to the laryngeal model capable of generating said correlate. This process of approximation to the modeling of phonatory system is more introspective than any other existing analysis method, since it models the biomechanical structures ultimately responsible for the production of the voice, which are the vocal folds or vocal cords. While reviewing the prior art, and during the presentations of speech technologies witnessed at national and international level, as well as reviewing the specialist publications and the patent databases, no reference along the same lines as that which is being proposed have been found. Another competitive advantage of the proposed invention is that it may be readily personalized to offer different solutions, ranging from independent medical or forensic professional to primary or specialist health care services to security bodies or forces, to the field of private security, to secure access to physical installations and computer services and to the management of customer service optimization, etc.

By making reference to patents dealing with similar topics, after consulting corresponding databases, the following may be cited as well as their connection to the application:
European Patent Application EP 2 124 223 A1:

### Method and System for Diagnosing Pathological Phenomenon Using a Voice Signal

The objective of the patent referred to is to detect psychoacoustic type pathologies or the biochemical imbalance which may be determined by means of analyzing the speech of the patient, such as the primary pathologies, dyslexia, attention deficit disorder, attention deficit hyperactivity disorder, autism, Parkinson's, Alzheimer's, sensory perception disorder, hearing problems, depression, motor control and lethargy and such secondary pathologies as, cardiopulmonary conditions, juvenile diabetes, differences in dopamine and serotonin, excess of norepinephrine, testosterone, serotonin and acetylcholine or its regulation, pathologies in the sacral or genital area and problems with the immune system. In terms of the materials, the cited patent advocates the use of the voice and speech without making a distinction between the two concepts, although it is clear that it refers to the speech of the patient when it says “wherein the speech has a finite duration and each time period separating the respective plurality of sample intensity values is essentially evenly distributed within the duration of the speech” (claim 12, col. 13, I. 21-26). In terms of the methodology of that which is expressed in the technical description, it is clear that spectral analysis of the speech signal of the patient is proposed when it says “For the purposes of describing and claiming the present invention, the term “crater feature” is intended to refer to a shape (on a graph of frequency vs. intensity) which manifests a sharp drop at a first frequency continued by a relatively low level along approximately 50 Hz or more and then a relatively steep rise at a second frequency.” (FIELD OF THE INVENTION, col. I, 1. 18-24). In this patent, a pattern classification process or modeling of a database of normal and/or pathological subjects making reference to the detection of each pathology, is shown. Therefore it is assumed that said detection process is based on highlighting a number of features without there existing a measuring and validation mechanism for the method. The invention proposed in this application has advantages over the patent referred to such as envisaging the detection of organic pathology of the phonatory device including alterations to the vocal folds, such as polyps, nodules, edemas, carcinoma of the vocal folds, paralysis of the vocal folds, etc and disturbances produced by deterioration of the upper or neuromotor centers, exclusively affecting the larynx. Moreover, the proposed invention in this application advocates the use of the voice as a biometric marker for secure access and forensic comparison. All of these objectives are radically different from those claimed by the patent referred to, adding value to its capacity to detect, its robustness and its accuracy. In terms of materials, the application advocates the utilization of vibration correlates of the vocal folds such as glottal excitation, mucosal wave or glottal residual which should be extracted by inverse filtering of the phonated segments of the voice, preferably of sustained vowels. In terms of the methodology used in this application, based on the glottal wave obtained by inverse filtering of the phonated segments (inversion of the spoken signal), cepstral parameters, singularities of the power spectral density and biomechanical parameters are calculated which are extracted for each phonation cycle in segments of about 200 msg. of phonation, which assumes samples taken at a rate of about 100-200 per second. Temporal parameters are also used in this application obtained for each phonation cycle by means of wavelet transforms. In the proposed application, different models for pattern classification, patient standards and analysis and statistical validation of the results are presented. Methods for grading dysphonia, secure access and forensic comparison are also shown. The new solution proposed in this application improves on that which is presented in the patent referred to for obtaining glottal waves specifically instead of the complete voice, for estimating a set of parameters with high functional dysphonia semantics and for the robustness and accuracy of the estimations compared to the intra-speaker variability, improving the capacity for inter-speaker separation. These innovations create substantial differences between that described in said patent and this application in terms of making reference to objectives, materials and methodology used, with the new solution proposed being more advantageous with respect to offering more parameters with improved semantics, less intra-speaker variability and greater accuracy and robustness.
US Patent Number USOO5400434A

### Voice Source for Synthetic Speech System

The objective of the patent referred is to use the glottal excitation signal previously extracted from a set of reference speakers in order to be reproduced in a synthetic text voice system. The methodology uses inverse filtering to generate the glottal wave without specifying the type of inverse filtering which must be used. The material used is registered speech from a database of speakers from which the glottal pulse is extracted. This application uses a type of inverse filtering based on mirror model lattices, which are an innovation in themselves. These lattice filters are standard for the joint estimation processes. The new solution proposed in this application improves on that which is presented in the patent referred to for obtaining glottal wave instead of the complete voice, for estimating a set of parameters with high functional dysphonia semantics and for the robustness and accuracy of the estimations compared to the intra-speaker variability, improving the capacity for inter-speaker separation. These innovations create substantial differences between that described in said patent and this application in terms of making reference to objectives, materials and methodology used, with the new solution proposed clearly being more advantageous with respect to offering more parameters with improved semantics, less intra-speaker variability and greater accuracy and robustness.
US Patent Number USOO5577160A

### Speech Analysis Apparatus for Extracting Glottal Source Parameters and Formant Parameters

The objective of the patent referred to is to reconstruct the glottal source together with the transfer function of the vocal tract, combining analysis algorithms based on lineal prediction. To this end, they use knowledge in the public domain, fundamentally published by P. Alku and others (OTHER PUBLICATIONS). The patent is based on the integration of different spectral analysis methods in the public domain, following connection structures of said methods allowing the authors to produce estimations of defined parameters of the glottal source (SOURCE PARAMETER EXTRACTING MEANS: Fundamental Frequency F0, Amplitude of waveform B, Open Quotient OQ, SK, C, D), as well as of the vocal tract (FIRST TO SIXTH FORMANT: F1-6). The parameters extracted in this way are combined in a spectral model of the glottal flow derivative and in a model of the vocal tract, which together define a complete model of speech desired (FIG. 27 and FIG. 28 of the document referred to). The methodology used is classic LPC (Linear Predictive Coding) filtering by means of transversal predictors, the estimation of the poles and zeros thereof and its use in the estimation of the influence of the vocal tract in staggered steps following the AIF (Adaptive Inverse Filtering) model of P. Alku (in the public domain) to generate the glottal source and by means of Fast Fourier Transfer (in the public domain) to generate two models in the frequency domain, of the glottal source and of the transfer of the vocal tract which combined and inverted to the domain of time provide a description of analyzed and synthesized speech. The method consists of carefully controlling the number of formants detected in the modeling of the glottal source and the vocal tract in order to avoid the intrusion of components of the vocal tract into the glottal source during the LPC modeling of the latter. Attempts are made to obtain more accurate estimations of both components with respect to the prior art. To this end, it is proposed to use a system called AbS (Analysis by Synthesis) to model the glottal source instead of the classic LPC which is reserved for the modeling of the vocal tract. The process of modeling the glottal source by AbS goes through eliminating the first formant of the voice according to a plurality of candidates, generating a plurality of glottal sources when eliminating the candidates different to the first formant. These sources are combined with the estimation of the vocal tract to synthesize voice which is compared with the original and allows the most appropriate candidate to be selected. The originality of this methodology is in the selective detection and elimination of the formants of the vocal tract (the first formant and the upper formants in a differentiated manner) to synthesize a glottal source prototype which is better adapted to the reduced profile of the voice by selectively eliminating formants. To this end, the estimations of the parameters F0, OQ, SK, C and D) are used as well as the formants F1-6. In turn this application advocates the utilization of the AIF model with the originality of carrying out crossed estimations of the glottal wave and vocal tract by means of LPC filters implemented by means of mirror model lattices as shown in FIGS. 2 and 5, controlling the orders (number of stages) of said lattices in an empirical manner. In this way, the solution proposed in this application is respectful of the biometric and biomechanical patterns which appear in the glottal source and which are not respected by the cited patent, consequently they substantially improve the characterization capacity thereof. The new solution proposed in this application improves on that which is presented in the patent referred to for obtaining glottal wave specifically instead of the complete voice, for estimating a set of parameters with high functional dysphonia semantics and for the robustness and accuracy of the estimations compared to the intra-speaker variability, improving the capacity for inter-speaker separation. These innovations create substantial differences between that described in said patent and this application in terms of making reference to objectives, materials and methodology used, with the new solution proposed clearly being more advantageous with respect to offering more parameters with improved semantics, less intra-speaker variability and greater accuracy and robustness.
US Patent Number US007398213B1

### Method and System for Diagnosing Pathological Phenomenon Using a Voice Signal

This is the extension of the mentioned European patent European Patent Application EP 2 124 223 A1 to the United States, the same considerations are consequently applicable to this patent as to the European patent, without any further additions.
US Patent Number US 20050171774A1

### Features and Techniques for Speaker Authentication

The objective of the patent referred to seems to be the utilization of parameters extracted from the glottal source, from the formants, from the temporal characteristics and from the fundamental frequency of speech as elements to recognize speakers. In terms of the parameters of the glottal source, the following is cited: the peak amplitude, the RMS amplitude (effective value), the rate of crosses through zero, the auto correlation function, the longitude of the arc, the Fourier coefficients, the trajectory in the complex plane of the Discrete Fourier Transform, the rate of decline with frequency (spectral tilt), the ratios of amplitude and phase of the primary harmonics, the degree of air in the voice (aspiration noise, high OQ coefficient (open quotient), the noise component, its crosses through zero and energy, the result of its Fourier analysis, jitter and shimmer, the ratio of different correlation coefficients of said signal with respect to the first, the phase information between differently standardized glottal sources. The formant parameters are the first nine and their respective bandwidths. The vocal tract profile and nasality are also added. In terms of methodology to establish the comparisons, an architecture with an extraction system next to the speaker is added from which the acoustic correlates are taken for analysis. They are transmitted by a communications network to a remote server where they are verified against a previously created database of speakers, with the authentication decision being returned to the next system (FIG. 1). The description of the methods to be used is not very accurate. The speaker authentication method mentioned is not specified. The points relating to this application center on the utilization of parameters derived from the glottal wave, even though they are completely different in their conception (primary harmonics, jitter and shimmer, without specifying which of the different parameterizations existing in the literature in the public domain are proposed), trajectories in the z plane, crosses through zero, all of these very similar to this application (based on distortion and cepstral parameters, singularities of the power spectral density of the glottal wave, biomechanical parameters, temporal parameters of glottal efficiency, which have a semantic clearly superior to those used in the patent mentioned). The new solution proposed in this application improves on that which is presented in the patent referred to for obtaining glottal wave specifically instead of the complete voice, for estimating a set of parameters with high functional dysphonia semantics and for the robustness and accuracy of the estimations compared to the intra-speaker variability, improving the capacity for inter-speaker separation. These innovations create substantial differences between that described in said patent and this application in terms of making reference to objectives, materials and methodology used, with the new solution proposed clearly being more advantageous with respect to offering more parameters with improved semantics, less intra-speaker variability and greater accuracy and robustness.
International Publication Number WO 2010/031437 A1

### Method and System of Voice Conversion

The objective of the patent referred to is to convert the voice of a speaker (object) into the voice of another speaker (objective) by means of the modeling of the glottal source and the vocal tract in each glottal cycle, including the intensity of the excitation, a set of parameters of the glottal source and the coefficients of the all-pole filter which model the vocal tract. The methodology used is extraction of the glottal source and the vocal tract by means of the joint estimation model of Lu & Smith in order to obtain a set of glottal wave and vocal tract model parameters, setting the glottal source obtained by inverse filtering against a Rosenberg-Klatt model by means of constrained nonlinear optimization. By way of this method, a vector of characteristics of the glottal wave formed by the intensity of the excitation (Ee), the temporal parameters of maximum flow (Tp), open phase (Te), return setting (Ta) and end of recovery (Tc), together with the aspiration noise energy (ANE). A database with different speakers is generated estimating these parameters. Then the results of the voice crossed synthesis by means of objective and subjective estimations are presented. The connection with this application centers on the methods of glottal wave extraction, even though the joint glottal wave and vocal tract estimation is carried out in both cases by quite different methods: the joint estimation by Lu & Smith using nonlinear optimization parameters in the case of the patent and mirror model adaptive lattices in the case of this application. The new solution proposed in this application improves on that which is presented in the patent referred to for obtaining glottal waves specifically instead of the complete voice, for estimating a set of parameters with high functional dysphonia semantics and for the robustness and accuracy of the estimations compared to the intra-speaker variability, improving the capacity for inter-speaker separation. These innovations create substantial differences between that described in said patent and this application in terms of making reference to objectives, materials and methodology used, with the new solution proposed clearly being more advantageous with respect to offering more parameters with improved semantics, less intra-speaker variability and greater accuracy and robustness.
US Patent Number US006195632B1

### Extracting Formant-Based Source-Filter Data for Coding and Synthesis Employing Cost Function and Inverse Filtering

The objective of the patent referred to is to calculate the formants of the voice by means of minimizing a cost function defined over the glottal residual called the arc length. The methodology operates in the following manner: the voice signal is subjected to inverse filtering to evaluate the glottal residual via which a cost function is evaluated. An optimization process is carried via the latter which allows the setting parameters of the inverse filter to be detected and to reconstruct the synthesized voice to compare its quality. The parameters to be set are the poles of the inverse filter and their bandwidths, while the quality measurement is based on the fixation of a series of reference points on the glottal correlate and in the calculation of the tension of the arc resulting between each pair of points accumulated as a mean square. The parameters of the inverse filter are suitably modified so that the tension measurement of the resulting are iteratively minimizes. An optimum glottal correlate and inverse filter can thereby be defined in this sense. The connection with this application centers on the glottal wave extraction methods, even though the estimation for the glottal wave and vocal tract is carried out in both cases by quite different methods: the estimation of the source and the filter by means of optimizing the arc tension function in the case of the referenced patent and by mirror model adaptive lattices illustrated in the FIGS. 2 and 5 in the case of this application. The new solution proposed in this application improves on that which is presented in the patent referred to for obtaining glottal waves specifically instead of the complete voice, for estimating a set of parameters with high functional dysphonia semantics and for the robustness and accuracy of the estimations compared to the intra-speaker variability, improving the capacity for inter-speaker separation. These innovations create substantial differences between that described in said patent and this application in terms of making reference to objectives, materials and methodology used, with the new solution proposed clearly being more advantageous with respect to offering more parameters with improved semantics, less intra-speaker variability and greater accuracy and robustness.

### DESCRIPTION OF THE INVENTION

### Introduction

The limitations identified in the current prior art in the area in which it claims to work are the following:
The influence of the vocal tract on phonation is strongly masking the dynamic activity of the vocal folds and makes the estimation of the physiological state of the latter very difficult based on the registration of the voice.
The calculations of the physiological state of the vocal folds based on the acoustic analysis of the voice are centered on the use of distortion parameters which do not have well defined and unambiguous semantics with respect to the problem which they model.
The personalization of the speaker based on the speech incorporates much articulatory information, depending on the text, which generates a high intra-speaker variability making the tasks of robust identification difficult.

The present invention resolves the previous problems and limitations by means of the following actions:
Parameters derived from the glottal wave are used to determine the dynamic activity of the vocal folds by means of reconstructing said signal by inverse filtering of the voice signal. The new parameters are estimates from the spectral envelope at the frequency of the glottal wave reconstructed in this way.
Estimations of the biomechanical parameters of the vocal folds are carried out by means of the adaption of a resonant biomechanical model which reconstructs the frequency behavior at a given band for the spectral envelope of the glottal wave. The biomechanical parameters are estimated by means of values of the biomechanical model cited by means of inversion of the dynamic system thereof. These new parameters determine normal and abnormal behaviors of the vocal folds during phonation in a much more direct manner.
The influence of the vocal tract during phonation is eliminated by means of inverse filtering which reduces the intra-speaker variability produced by articulation. This improves the inter-speaker discrimination rates to better separate the classes of speaker modelings.

To this end, a recording system for the voice signal is proposed and a set of algorithmic methods designed to extract relevant parameters from the glottal wave and to classify them in accordance with a standard control population which allows the presence of dysphonia, the degree thereof and the identity of the speaker to be determined.

### BRIEF DESCRIPTION OF THE DRAWINGS

FIG. 1. General diagram of the system describing the invention consisting of a sound recording system (1-2), followed by a digital coding device (3) under the control of a programmable logic circuit (4) which carries out the control (5), storage (6), estimation of parameters and classification functions thereof (7, 8, 9) and presentation (10) or providing another system (11) for them to be interpreted by an expert.

FIG. 2. Process for estimating the glottal wave by inversion of the production model of the voice. The radiation effect (12) is eliminated, the glottal pulse (13) is modeled, the influence thereof (14) is eliminated, the vocal tract (16) is modeled and the influence thereof (15) is also eliminated, the estimations crossing with (glottal or vocal) influence eliminated in order to carry out successive refinements on the modelings. A residual glottal signal is generated as a result without substantial influence of the vocal tract.

FIG. 3. Process for estimating the reference parameters to be used in the preferred embodiments (clinical, speaker identification and forensic). By means of two successive integrations (17) and (18), the glottal source and the glottal flow are estimated. The glottal source is used to estimate the temporal parameters of the glottal cycle (19), the distortion parameters (20), and the mean acoustic wave (21). Based on this signal, the power spectral density (22) of the mucosal wave correlate is calculated, which allows the biometric parameters of phonation (23) as well as the biomechanical parameters of the cover of the vocal folds (25) to be estimated. Based on the mean acoustic wave, the biomechanical parameters of the body of the vocal folds (24) may be calculated.

FIG. 4. Cancelling filter for the radiation effect. This is constructed as a partial correlation lattice, which is the start of a chain of modeling and crossed cancellation filters, which are called mirror model.

FIG. 5. Mirror model lattice filters for joint estimation. Stage of a modeling and cancellation filter which shows the flow to be modeled (33-33′) and the modeled flow (37-37′) as well as the estimation method (34) and crossed re-correlation (35, 38), the flows passing to the following stage (36-36′) and (39-39′) being generated.

FIG. 6. Example of reconstruction of the glottal source resulting from (17-18) for the masculine voice. The glottal (wave) source is given by (40) while the glottal flow is (41). In (42), successive cycles of the glottal flow may be seen.

FIG. 7. Example of reconstruction of the glottal source resulting from (17-18) for the feminine voice. The glottal (wave) source is given by (43) while the glottal flow is (44). In (45), successive cycles of the glottal source may be seen.

FIG. 8. Profile (envelope) of the power spectral density of the glottal source. A mean decline function inversely proportional to the frequency is observed, peppered by successive peaks (46) and troughs (47) constituting the singularities of said profile and which, duly estimated in value and standardized position, produce the biometric parameters of said glottal source.

FIG. 9. Adjustment of the power spectral density of the mean acoustic wave (48) by means of a second order function (49), the adjustment parameters of which are converted into estimators for the biomechanics of the body of the vocal folds.

FIG. 10. Adjustment of the power spectral density of the mucosal wave (50) by means of a second order function (51), the adjustment parameters of which are converted into estimators for the biomechanics of the body of the vocal folds.

FIG. 11. Preferred exemplary embodiment for the application of the method and system proposed for detecting and grading dysphonia. The voice signal (55) is captured and stored (52, 54, 53), and via the same, the glottal source (56) is extracted. The biometric and biomechanical (57) parameters are estimated and the most relevant parameters for the desired application (58) are selected. With a sufficient quantity of normophonic individuals, a model of the reference speaker (58) is generated which is used in contrast by means of classifying parameters based on different algorithms such as Gaussian mixture models (60: GMM), not excluding other possible models. A dysphonic grade index (61) which may be used to evaluate the level of dysphonia (62: 0-1 normal, 1-2 slight, 2-3 moderate, >3 serious) and to decide (63) possible consequent actions such as a examination at a specialist service center, etc.

FIG. 12. Preferred exemplary embodiment for the application of the method and system proposed for identifying and verifying the speaker. The voice signal (67) is captured and stored (64, 66, 65), and via the same, the glottal source (70) is extracted. The cepstral parameters (71) are estimated based on the conventional spectrum (68), the cepstral parameters derived from the LPC spectrum (69) and the biometric and biomechanical (73) parameters of the glottal source (70) with which a supervector (74) is composed, which is used to detect the temporal sequence (75) and the grade of similarity (76) with respect to a previously produced speaker model (77). The scores of similarity for identifying one speaker from others (78) is used to generate a number of indexes of identity and certainty (79) which provide information about the estimated personality and reliability of the estimation. With this information, decisions can be made regarding the acceptance, rejection or personality evaluation using alternative methods (80).

FIG. 13. Preferred exemplary embodiment for the application of the method and system proposed for verifying and forensically comparing the speaker. The voice signal (84) is captured and stored (81, 83, 82), and via the same, the glottal source (85) is extracted. The biometric and biomechanical (86) parameters are estimated and the most relevant parameters for the desired application (87) are selected. With a sufficient quantity of normophonic individuals, a universal speaker model (88) is generated which is used in contrast by means of classifying parameters based on different algorithms such as Gaussian mixture models (89: GMM), not excluding other possible models. A plausibility index (61: LR) is generated which can be used to evaluate the evidence of the comparison (91: <0 rejection, 0-1 weak evidence, 1-2 strong evidence, 2-3 very strong evidence) and decide (92) possible consequent actions.

### PREFERRED EMBODIMENT OF THE INVENTION

An embodiment of the invention will hereinafter, in a non-limiting manner, be illustrated with reference to figures.

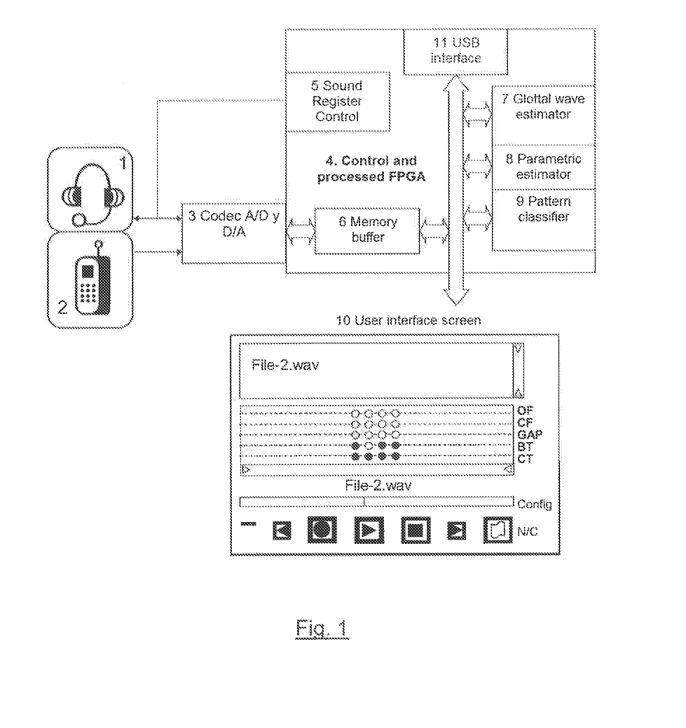

In order to describe the system proposed, the description will proceed from the block diagram which is shown in FIG. 1, illustrating the voice register platform, computation of the parameters and presentation of the same on a portable user interface. In the latter, the voice signal obtained from a conventional microphone (1) or from a telephone (2) is captured and digitally codified (3) and stored in a temporal memory (6) in a control circuit formed by a FPGA (4: Field-Programmable Gate Array) which also incorporates the suitable programming for controlling the sound capturing (5) and the rest of the signal treatment and pattern identification processes (7: glottal wave estimator, 8: reference parameter estimator, 9: pattern classifier). The results are also stored in a temporal memory (6) from where, or either they provide the user (10) with an iPod type screen or they make other computer systems available by means of a USB interface (11).

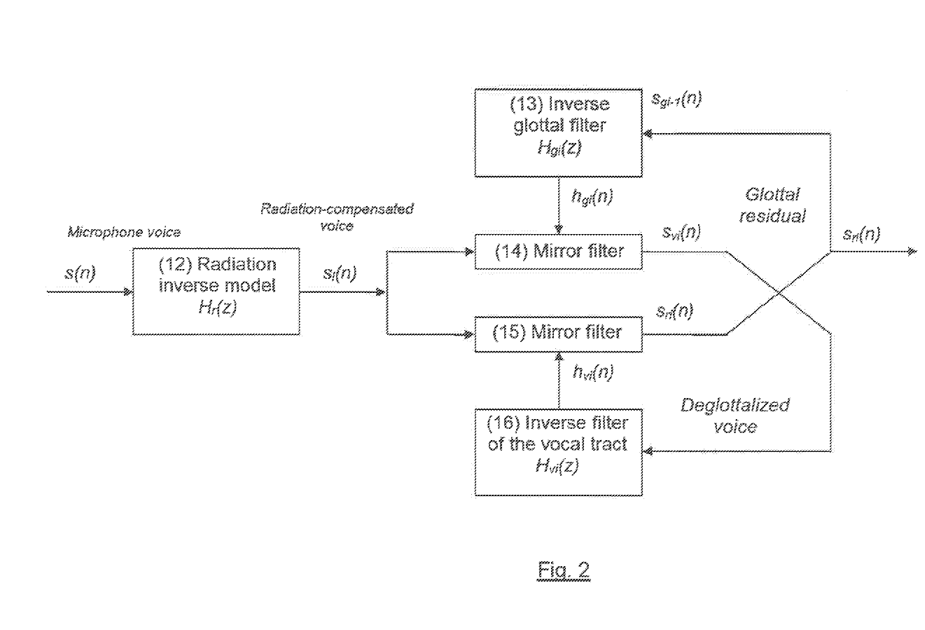

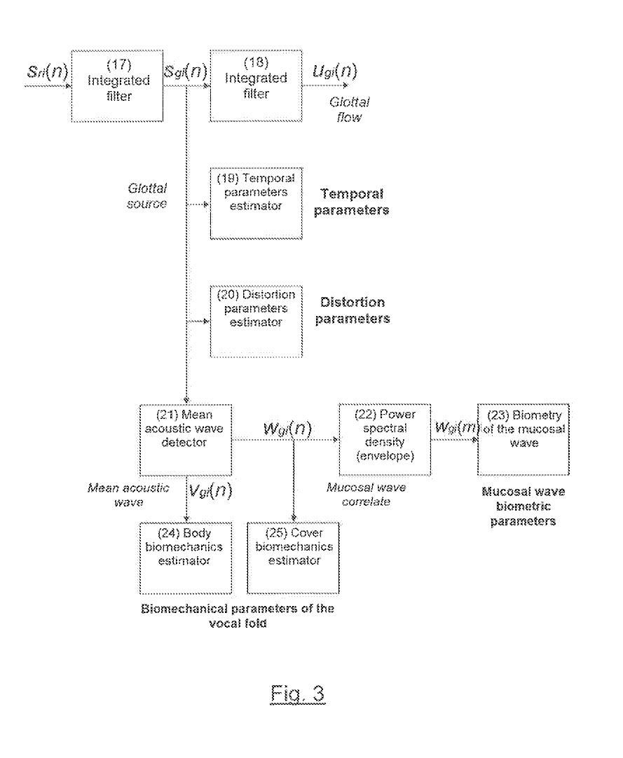

The method proposed in turn consists of a series of processes for estimating the classification parameters programmed into the FPGA in FIG. 1. These are the following processes:
Process for estimating the glottal wave, described in FIG. 2, consisting in an inverse filter (12) compensating for the radiation effect from the lips on the microphone and a pair of mirror model filters which model the behavior of the glottal wave and the vocal tract and eliminate them on the voice signal. The inverse glottal filter system (13) models the glottal wave and its mirror filter (14) eliminates the influence of the same in the voice, producing a deglottalized voice. The inverse filter system of the vocal tract (16) models the resonances of the pharyngeal, vocal and nasal cavities and the mirror filter thereof (15) eliminates the latter in the voice signal, producing a glottal residual.
Process for estimating the reference parameters, described in FIG. 3. The glottal residual produced in the previous process is integrated into an integrator filter (17) and produces the glottal source. The integration of this signal in a new integrator filter (18) produces the glottal flow. The glottal source in turn is used for estimating its temporal parameters (19) and its distortion parameters (20). Additionally, via the latter the mean acoustic wave is estimated in a mean acoustic wave detector (21), which also produces a mucosal wave correlate. Based on the mucosal wave correlate, the power spectral density of its envelope in (22) is estimated, via which the biometric parameters of the mucosal wave (23) are estimated. The biomechanical parameters of the cover of the vocal folds (25) are also estimated based on the mucosal wave correlate. The biomechanical parameters of the body of the vocal folds (24) are estimated from the mean acoustic wave.

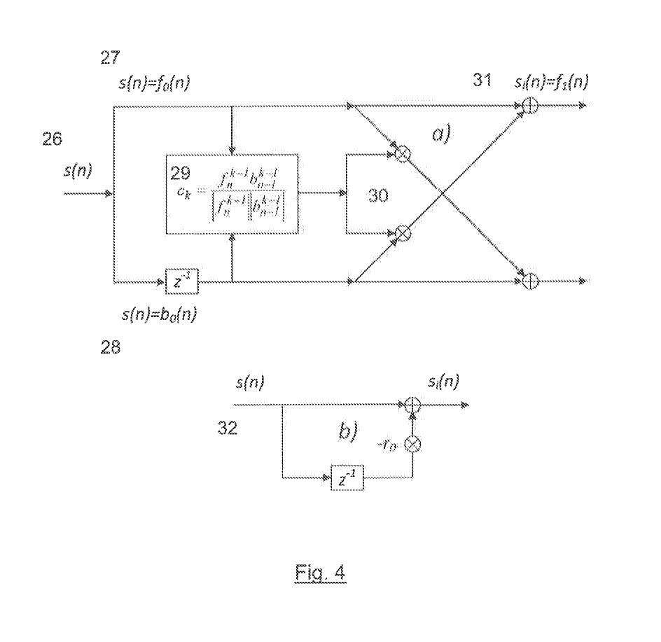

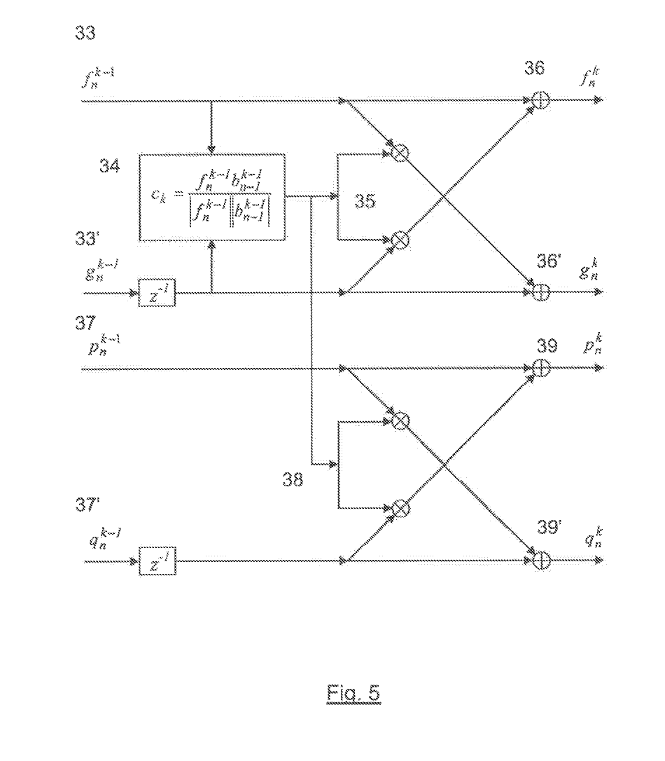

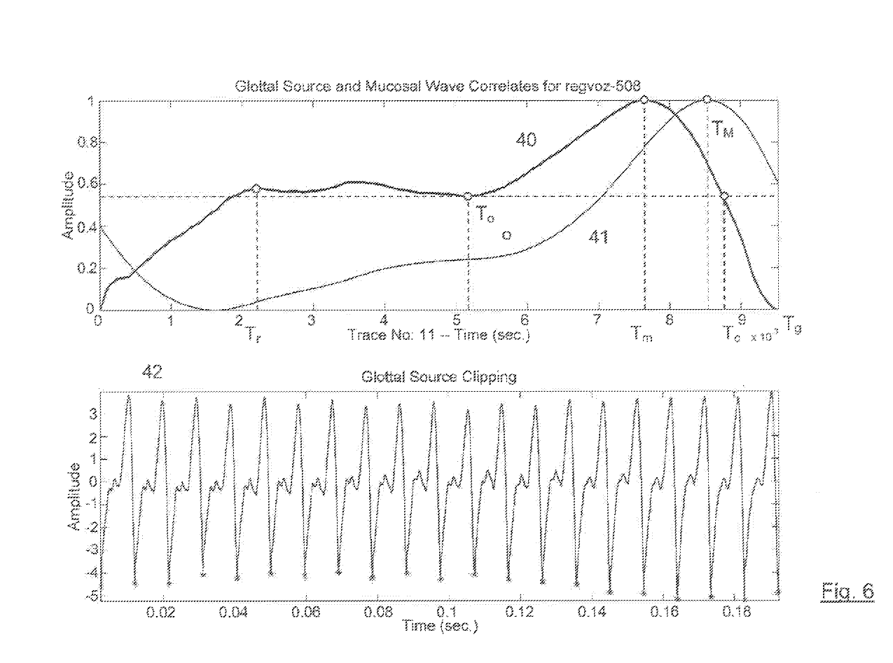

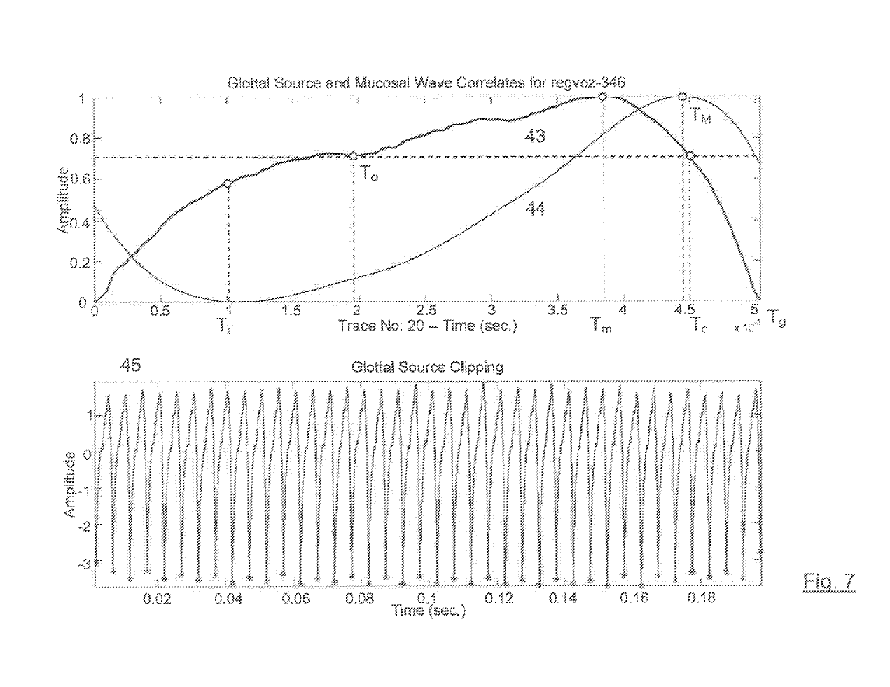

In the methods for reconstructing the glottal wave residual in FIG. 2, the inverse filters proposed play a significant role as they are an important part of the present application since they improve the robustness of the estimation processes used in the prior art and are more accurate than the conventional autoregressive types. Hereinafter, each one of the blocks in FIGS. 2 and 3 will be described in greater detail:
Block (12): FIG. 4 shows the structure of the filter which cancels the radiation effect (32) equivalent to block (12) of FIG. 2, which is implemented by means of an adaptive lattice in such a way that the voice signal (26) is divided into two branches (27) and (28) and fed to a PARCOR estimator (29) which is used for cancelling the crossed correlation in (30) between obsolete (27) and (28), generating the signal free from the radiation effect (31).
Blocks (13)-(14) are constructed as mirror model filters, described in FIG. 5. In this Figure, the modeling filter receives the direct (33) and reverse (33′) propagation signals originating from the glottal signal via which a partial correlation coefficient (34) is estimated which is used in (35) to eliminate said correlation, producing two new direct (36) and reverse (36′) propagation signals. The same partial correlation coefficient (34) is applied to the direct (37) and reverse (37′) propagation flows originating from the voice signal in the mirror filter to eliminate said crossed correlation (38), producing two new direct (39) and reverse (39′) propagation flows. These paired lattice filters may be chained to constitute an order system suitable for the type of modeling required. In the system (13)-(14), there will usually be sufficient chaining of one to three of these stages.
Blocks (15)-(16) are constructed as mirror model filters, described in FIG. 5. In this Figure, the modeling filter receives the direct (33) and reverse (33′) propagation signals originating from the deglottalized voice via which a partial correlation coefficient (34) is estimated which is used in (35) to eliminate said correlation, producing two new direct (36) and reverse (36′) propagation signals. The same partial correlation coefficient (34) is applied to the direct (37) and reverse (37′) propagation flows originating from the voice signal in the mirror filter to eliminate said crossed correlation (38), producing two new direct (39) and reverse (39′) propagation flows. These paired lattice filters may be chained to constitute an order system suitable for the type of modeling required. In the system (15)-(16), it may be necessary to chain dozens of these stages, depending on the accuracy desired in the estimations and on the frequency of the sampling of the signals.
Blocks (17)-(18) are constructed as simple integrators of the signal which receive its input for which different algorithms may be used with or without leakage to ensure the compensation of the continuous drift.
Block (19) Temporal parameter estimator. It is designed so that the relevant temporal parameters in the glottal signal, shown in FIG. 6 (masculine voice) and 7 (feminine voice), may be suitably determined. The temporal base parameters of the phonation cycle refer to the singular moments of the phonation cycle as they are illustrated in the figures cited, which are:
   Starting time of the glottal closure. This is the point at which the glottal source reaches its minimum value in the form of a negative sharp spike (starting point of FIGS. 6 and 7, (40 and 43), equivalent to the points marked with an asterisk /*/ on the template directly below that referred to in said figure), resulting from the depression which the abrupt interruption of the flow produces in the supraglottal area, while the air column present in the vocal tract continues its exit movement given its inertial behavior. t=0 is taken as the origin of the glottal cycle.
   Recovery time t=Tr. When a channel, through which a fluid circulates, is abruptly closed, a retroaction is produced expressed as a negative pressure peak as a vacuum is produced by the inability of the moving fluid to instantaneously stop due to it having an inert mass. This causes a regression on the part of the fluid which compensates for the pressure drop after a short time. The recovery time is the temporal point at which the partial regression of the air column present in the vocal tract once again balances the supraglottal pressure to that of rest pressure (atmospheric or reference pressure).
   Starting time of the opening t=To. This is the point at which the vocal cords incipiently start to open again.
   Time of maximum excess pressure t=Tm. This is the point at which the maximum supraglottal pressure is reached.
   Starting time of closure t=Tc. This is the point at which the maximum opening or gap between the vocal folds is reached, corresponding to the maximum flow if the influence of the vocal tract can be discarded, from which the gap between the folds (opening) begins to decrease.
   Final time of the glottal cycle t=Tg, This is the point at which the minimum supraglottal pressure is reached and coincides with the start of a new cycle.

Via the glottal source (coarse signal) four reference times are estimated in the temporal parameterization: the return time (Tᵣ), the opening time (Tₒ), the time of maximum amplitude (Tₘ) and the starting time of closure (T_{c}). The complete duration of the glottal cycle is given by T_{g}. The temporal parameterization is based on the estimation of two signals from the glottal source: the mean acoustic wave sₛ(n) and the of the mucosal wave correlate s_{w}(n) as illustrated in the process (21). Via the glottal flow (thin signal), a reference time is estimated, coinciding with the maximum of said wave (T_{M}).

Block (20) Distortion parameter estimator. A series of distortion parameters are estimated which are jitter, amplitude shimmer, area shimmer, sharpness of closure and the cover to body ratio.

Block (21) The mean acoustic wave is a semi-sinusoidal signal which has a duration of a glottal arc for the masculine or feminine voice, (40) or (43), with an amplitude which minimizes the difference between its area and that of the glottal source. The estimation thereof is carried out for each phonation cycle and in a synchronous manner with the start and finish thereof, defined from minimum to minimum of the glottal source as shown in the templates (42) and (45) of FIGS. 6 and 7.

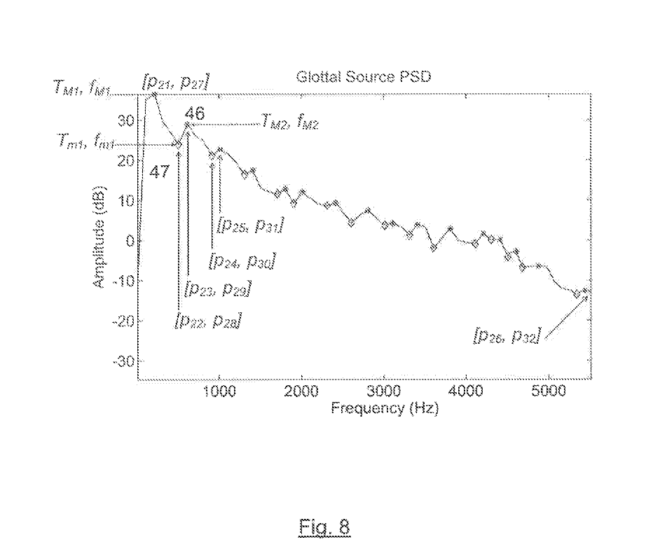

Block (22) Power spectral density estimator of the envelope of the glottal wave. The envelope of the power spectral density of the glottal correlate concerned (glottal wave, mucosal wave) is estimated as the Fourier Transfer module of a cycle of the cited wave and its aspect is similar to that described in FIG. 8.

Block (23) Biometric parameter estimator of the mucosal wave. The mean behavior of the envelope of the glottal wave or of the mucosal wave is a decline inversely proportional to the frequency, showing certain singularities in the form of alternate peaks (46) and troughs (47). The precise estimation of these peaks and troughs constitutes the set of biometric parameters of the envelope of the power spectral density of the wave referred to.

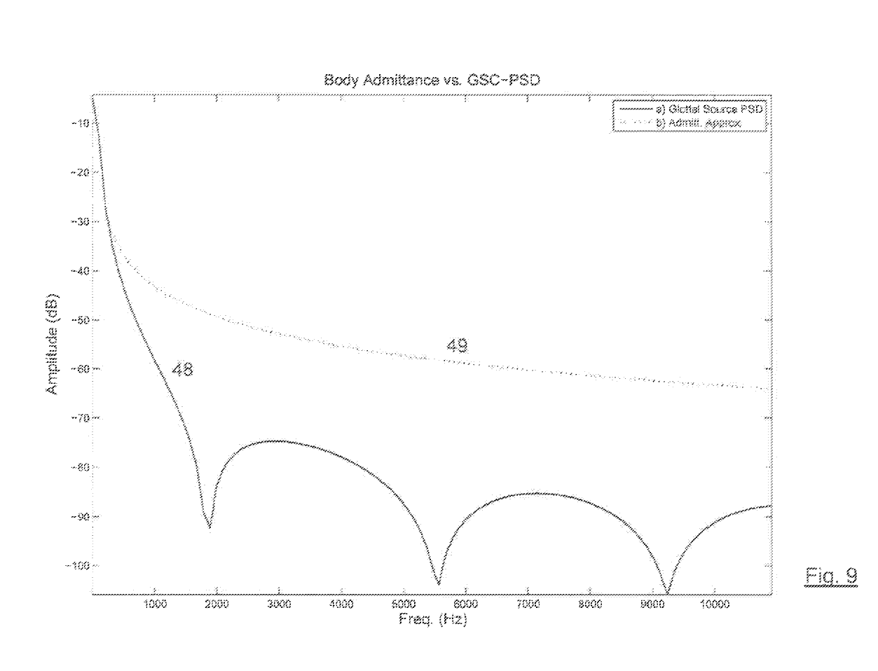

Block (24) Biomechanical estimator of the body of the vocal fold. This is based on the adjustment of a second order transfer function (49) via the spectral density of the mean acoustic wave (48) as shown in FIG. 9 in a low frequency range. The parameters of the adjustment transfer function constitute the biomechanical parameters of the body of the vocal fold.

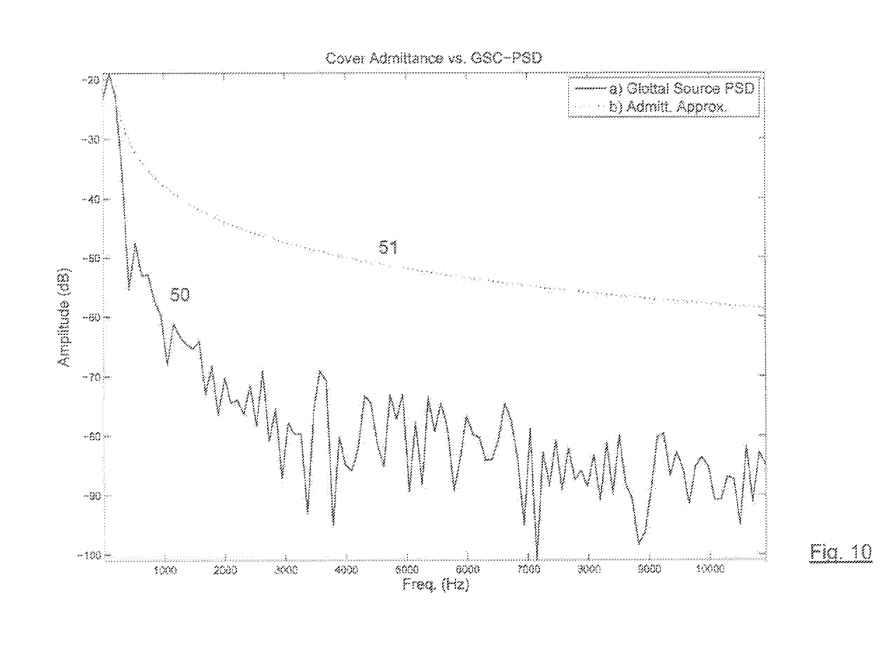

Block (25) Biomechanical estimator of the cover of the vocal fold. This is based on the adjustment of a second order transfer function (51) via the spectral density of the mucosal wave correlate (50) as shown in FIG. 10 in a low frequency range. The parameters of the adjustment transfer function constitute the biomechanical parameters of the cover of the vocal fold.

### Detailed Description of the Main Processes Carried Out in the Blocks

### Process (12). Inverse Radiation Model Hᵣ(z).

This process is carried out by means of a first order error prediction lattice as shown in FIG. 4 which operates like a FIR (Finite Impulse Response) filter according to recursion where n makes reference to the discrete temporal index:

fₖ(n)=fₖ₋₁(n)+cₖ₋₁bₖ₋₁(n−1) eq. 1

such that when k=1 and c₀=−rⱼ (first reflection coefficient) assuming that:

f₀(n)=b₀(n)=s(n) eq. 2

the lattice behaves like a first order differentiator:

s₁(n)=f₁(n)=s(n)−r_{f}s(n−1) eq. 3

with transfer function given by:

H₁(z)=R⁻¹(z)=1−r_{f}z⁻¹ eq. 4

which cancels the first order pole introduced by the radiation effects of the lips.

### Process (13). Inverse Glottal Filter H_{gi}(z).

As shown in FIG. 2, the function of the inverse glottal filter is to construct a spectral inversion model of the signal at its input which is the glottal wave residual to be modeled sᵣᵢ(n). During the modeling, a number of pivotal coefficients {cₖ}→{h_{gi}} are obtained which, injected into other similar lattices (mirror filter), allow the spectral trace of the modeled signal to be eliminated on a different signal, in this case the radiation-compensated voice signal sₗ(n), producing the deglottalized voice sᵥᵢ(n). The estimation of the pivotal coefficients can be carried out in a block manner or in an adaptive manner. Both mechanisms are used by the method proposed in the application.

### Process (14). Deglottalization Mirror Filter.

As shown in FIG. 2, the function of a mirror filter is to carry out the deconvolution of the signal at its input with respect to a set of parameters {cₖ}→{h_{gi}} estimated in a supply model which obtains the same and injects them into the mirror filter. The two filters, inverse modeling and its mirror, constitute a joint process estimator and its implementation by means of lattices may be seen in FIG. 5, which shows a stage of this type of structure. The K replication of these stages allows the K order joint estimator to be constructed. In this case, the signal to be processed is the radiation-compensated voice (sₗ(n) reduced to the labial point), producing the deglottalized voice signal sᵥᵢ(n).

### Process (15). Mirror Filter for Eliminating the Spectral Influence of the Vocal Tract

According to FIG. 2, the parameters of the inverse modeling filter of the vocal tract {cₖ}→{hᵥᵢ} (16), injected into the corresponding mirror filter (15), eliminate the influence of the articulatory processes from the radiation-compensated voice signal sₗ(n) and consequently leave the glottal residual sᵣᵢ(n).

### Process (16). Inverse Filter of the Vocal Tract Hᵥᵢ(z).

Also referring to FIG. 2, the functioning of this type of system is similar to that described in (13), although in this case, the signal modeled is the deglottalized voice signal sᵥᵢ(n). In this way, a set of pivotal coefficients {cₖ}→{hᵥᵢ} is derived which model, in inverse form, the frequency behavior of the vocal tract.

### Process (17). Integrated Filter Estimator of the Glottal Source

According to FIG. 3, the glottal source s_{gi}(n) is generated from the glottal residual sᵣᵢ(n) by simple integration by means of the expression:

s_{gi}(n)=s_{gi}(n−1)+rₗsᵣᵢ(n) eq. 5

where rₗ is a excess control coefficient whose purpose is the avoid the accumulation of these undesired effects.

### Process (18). Integrated Filter Estimator of the Glottal Flow.

According to FIG. 3, the glottal flow u_{gi}(n) is generated from the glottal source s_{gi}(n) by way of simple integration by means of the expression:

u_{gi}(n)=u_{gi}(n−1)+rₗs_{gi}(n) eq. 6

where rₗ is the corresponding excess control coefficient

### Process (19). Temporal Parameter Estimator of the Glottal Cycle.

An example of the cycle of the glottal source s_{gi}(n) may be seen in FIGS. 6 (masculine) and 7 (feminine). The temporal base parameters of the phonation cycle refer to singular moments of the phonation cycle as illustrated in FIG. 6, which are:
Starting time of the glottal closure. This is the point at which the glottal source reaches its minimum value in the form of a negative sharp spike (starting point of FIG. 6, upper, equivalent to the points marked with an asterisk /*/ in (42) or (45) resulting from the depression which the abrupt interruption of the flow produces in the supraglottal area, while the air column present in the vocal tract continues its exit movement given its inertial behavior. t:=0 is taken as the origin of the glottal cycle.
Recovery time t=Tr. This is the point at which the partial regression of the air column present in the vocal tract once again balances the supraglottal pressure to that of rest pressure (atmospheric or reference pressure).

Starting time of the opening t=To. This is the point at which the vocal cords incipiently start to open again.
Time of maximum excess pressure t=Tm. This is the point at which the maximum supraglottal pressure is reached.
Starting time of closure t=Tc. This is the point at which the maximum opening or gap between the vocal folds is reached, corresponding to the maximum flow if the influence of the vocal tract can be discarded, from which the gap between the folds (opening) begins to decrease.
Final time of the glottal cycle t=Tg, This is the point at which the minimum supraglottal pressure is reached and coincides with the start of a new cycle.

Via the glottal source (coarse signal) four reference times are estimated in the temporal parameterization: the return time (Tᵣ), the opening time (Tₒ), the time of maximum amplitude (Tₘ) and the starting time of closure (T_{c}). The complete duration of the glottal cycle is given by T_{g}. The temporal parameterization is based on the estimation of two signals from the glottal source: the mean acoustic wave sₛ(n) and the mucosal wave correlate s_{w}(n). Via the glottal flow (thin signal), a reference time is estimated, coinciding with the maximum of said wave (T_{M}). In accordance with the previous established definitions in Block (19), the estimation of each of the reference times is adjusted to the following methods:

$$\begin{matrix}{T}_{r} = arg [ {max}_{0 \leq n < {n}_{0}} \{ {s}_{mk} ( n ) \} ] & eq . 7 \\ {T}_{o} = arg [ {max}_{0 \leq n < {N}_{k}} \{ {s}_{wk} ( n ) \} ] & eq . 8 \\ {T}_{m} = arg [ {max}_{{n}_{o} \leq n < {N}_{k}} \{ {s}_{gk} ( n ) \} ] & eq . 9 \\ {T}_{c} = arg [ {s}_{gk} ( {n}_{o} \leq n < {N}_{k} ) = {s}_{gk} ( arg [ {min}_{0 \leq n < {N}_{k}} \{ {s}_{wk} ( n ) \} ] ) ] & eq . 10 \\ {T}_{M} = arg [ max \{ {u}_{gk} ( n ) \} ] & eq . 11\end{matrix}$$

The following temporal base parameters are also estimated, which are detailed hereinafter:
OQ, opening coefficient, which measures the relative duration of the period for which the glottis is open with respect to the duration of the glottal cycle T_{g}.
SQ, velocity coefficient, which measures the relation between the two parts of the opening cycle, before and after the point of maximum positive amplitude.
ClQ, closure coefficient, which measures the relation between the second half of the opening cycle, from the point of maximum positive amplitude to the time of closure and the duration of the glottal cycle T_{g}.
RQ, return coefficient, which measures the relation between the return period and the duration of the glottal cycle T_{g}.
NAQ, standardized amplitude coefficient, which measures the relation between the maximum value of the glottal flow (thin line curve) and the area of the lower quadrant of the glottal wave below Tₒ.
ArQ, relative amplitude coefficient of the return time with respect to the maximum amplitude.
AoQ, relative amplitude coefficient of the time of opening with respect to the maximum amplitude.

The previous parameters are estimated in the following manner:

$$\begin{matrix}OQ = \frac{{T}_{g} - {T}_{o}}{{T}_{g}} & eq . 12 \\ SQ = \frac{{T}_{m} - {T}_{o}}{{T}_{g} - {T}_{m}} & eq . 13 \\ CIQ = \frac{{T}_{g} - {T}_{m}}{{T}_{g}} & eq . 14 \\ RQ = \frac{{T}_{r}}{{T}_{g}} \\ CMQ = \frac{{T}_{M}}{{T}_{g}} & eq . 15 \\ NAQ = \frac{max \{ {u}_{gk} ( {n}_{o} \leq n < {N}_{k} ) \}}{{s}_{gk} ( {T}_{o} ) {T}_{g}} & eq . 16 \\ ArQ = \frac{{s}_{gk} ( {T}_{r} )}{{s}_{gk} ( {T}_{m} )} & eq . 17 \\ AoQ = \frac{{s}_{gk} ( {T}_{o} )}{{s}_{gk} ( {T}_{m} )} & eq . 18 \\ AMQ = \frac{{s}_{gk} ( {T}_{M} )}{{s}_{gk} ( {T}_{m} )} & eq . 19\end{matrix}$$

Lastly, an additional group of parameters are added which measure the efficacy of phonation as a relation between the efficacy of the air injection and the deficiency of the glottal closure (leakages due to defective closure) and which are defined as follows:
ODQ, defective opening coefficient, a parameter which estimates the diminishment of the mean flow in the glottal opening phase (from Tₒ to T_{g}) due to the presence of premature closure or deficient injection.
CDQ, defective closure coefficient, a parameter which estimates the mean flow in the glottal closure phase (from 0 to Tₒ) due to the presence of premature opening or deficiency due to leakage.
GEQ—glottal efficiency, a parameter which estimates the behavior of the deficiency of injection plus the deficiency due to leakage, as a merit factor in phonation.

The previous parameters are estimated in the following manner:

$$\begin{matrix}{W}_{s} ( σ , δ ) = \frac{1}{\sqrt{σ}} {\int }_{- ∞}^{∞} {ψ}_{g} ( \frac{t - δ}{σ} ) {s}_{gk} ( t ) d t \\ {L}_{c} = {\sum }_{δ < {δ}_{o}} {\vert {W}_{s} ( σ > {σ}_{1} , δ ) \vert}^{2} ; & eq . 20 \\ {L}_{o} = {\sum }_{δ \geq {δ}_{o}} {\vert {W}_{s} ( σ > {σ}_{1} , δ ) \vert}^{2} ; \\ {L}_{r} = {\sum }_{δ} {\vert {W}_{s} ( σ > {σ}_{1} , δ ) \vert}^{2} \\ ODQ = {γ}_{c} = \frac{{L}_{c}}{{L}_{r}} ; & eq . 21 \\ CDQ = {γ}_{o} = \frac{{L}_{o}}{{L}_{r}} & eq . 22 \\ GEQ = 1 - {γ}_{c} - {γ}_{o} & eq . 23\end{matrix}$$

Where s_{gk} is the glottal wave, ψ_{g} is a Gaussian wavelet, scalable in the σ parameter and displaceable in the δ parameter. The allocation table of temporal base parameters of the phonation cycle is as follows:

p₄₇ₖ=OQ; p₄₈ₖ=SQ; p₄₉ₖ=ClQ;

p₅₀ₖ=RQ; p₅₁ₖ=CMQ; p₅₂ₖ=NAQ;

p₅₃ₖ=ArQ; p₅₄ₖ=AoQ; p₅₅ₖ=AMQ;

p₃₆ₖ=ODQ; p₅₇ₖ=CDQ; p₅₈ₖ=GEQ; eq. 24

### Process (20). Estimator of the Distortion Parameters of the Glottal Source.

Based on the glottal source evaluated in the k-th phonation cycle:

s_{gk}(n)=s_{gi}(n); nₖ₋₁≦n<nₖ; eq. 25

where nₖ₋₁ and nₖ are the temporal limits above the k−1-th and k-th glottal cycles respectively with sizes given by:

Nₖ₋₁=nₖ₋₁−nₖ₋₂; Nₖ=nₖ−nₖ₋ⱼ eq. 26

A series of distortion parameters is estimated which are jitter, amplitude shimmer, area shimmer, sharpness of closure and the cover to body ratio, which are defined hereinafter. Jitter is estimated as:

$${P}_{2 k} = 2 \frac{\vert \frac{1}{{N}_{k}} - \frac{1}{{N}_{k - 1}} \vert}{\frac{1}{{N}_{k}} + \frac{1}{{N}_{k - 1}}} \qquad eq . 27$$

Amplitude shimmer is also estimated as:

$${p}_{3 k} = 2 \frac{\vert {s}_{gmk} - {s}_{gmk - 1} \vert}{{s}_{gmk} + {s}_{gmk - 1}} \qquad eq . 28$$

where s_{gmk} is the maximum amplitude value from peak to peak which takes the glottal source within the k-th cycle.

The area shimmer is also estimated as:

$${p}_{4 k} = 2 \frac{\vert {S}_{gk} - {S}_{gk - 1} \vert}{{S}_{gk} + {S}_{gk - 1}} \qquad eq . 29$$

where S_{gk} is the area closed by the peak to peak amplitude of the glottal source in the k-th cycle:

$${S}_{gk} = \frac{1}{{N}_{k}} {\sum }_{i = {n}_{k - 1}}^{{n}_{k}} {s}_{gk} ( n - i ) \qquad eq . 30$$

The sharpness of closure is defined for a point of closure given in n=nₖ:

$${p}_{5 k} = \frac{{s}_{gi} ( {n}_{k} ) - ( {s}_{gi} ( {n}_{k} - {n}_{w} ) + {s}_{gi} ( {n}_{k} + {n}_{w} ) ) / 2}{2 {n}_{w} + 1} \qquad eq . 31$$

where 2n_{w}+1 is the size of the temporal window around the point of closure.

The cover to body ratio is estimated as:

$${p}_{6 k} = \frac{{\sum }_{n ∈ {N}_{k}}^{ } {( {s}_{wk} ( n ) )}^{2}}{{\sum }_{n ∈ {N}_{k}}^{ } {( {s}_{sk} ( n ) )}^{2}} \qquad eq . 32$$

where sₛₖ(n) and s_{wk}(n) are the mean acoustic wave and the mucosal wave correlate, respectively.

### Process (21). Mean Acoustic Wave Detector

The mean acoustic wave is a semi-sinusoidal signal which has the duration of a glottal arc and whose amplitude meets a determined criteria as mentioned hereinafter. The estimation thereof is carried out for each phonation cycle and in a synchronous manner with the start and end thereof, defined from minimum to minimum of the glottal source (clipping) as shown in (42) or (45), such that with k being the index of the phonation cycle concerned, we have the following definitions:

s_{wk}(n)=s_{gk}(n)−sₛₖ(n) eq. 33

sₛₖ(n) and sₘₖ(h) are the mean acoustic wave and the mucosal wave correlate. The mean acoustic wave is a semi-sinusoid with half cycle equal to the duration of the phonation cycle T_{ck}:

s_{gk}(n)=s₀ₖsen(ωₖnτ); nεNₖ eq. 34

the corresponding pulsation being:

$${ω}_{k} = \frac{2 π}{{T}_{ck}} \qquad eq . 35$$

The amplitude of the semi-sinusoid representative of the mean acoustic wave is evaluated, minimizing the energy of the mucosal wave correlate:

$$\begin{matrix}{L}_{k} = {\sum }_{n ∈ {N}_{k}}^{ } {( {s}_{wk} ( n ) )}^{2} \\ = {\sum }_{n ∈ {N}_{k}}^{ } {( {s}_{gk} ( n ) - {s}_{sk} ( n ) )}^{2}\end{matrix} \qquad eq . 36$$

with respect to said amplitude:

$$\begin{matrix}\frac{\partial {L}_{k}}{\partial {s}_{0 k}} = 0 ⇒ {s}_{0 k} \\ = \frac{{\sum }_{n ∈ {N}_{k}}^{ } {s}_{gk} sen ( {ω}_{k} n τ )}{{\sum }_{n ∈ {N}_{k}}^{ } {sen}^{2} ( {ω}_{k} n τ )}\end{matrix} \qquad eq . 37$$

Consequently, the derivative of the mucosal wave correlate may be estimated as:

$${s}_{dk} ( n ) = \frac{{s}_{wk} ( n ) - {s}_{wk} ( n - 1 )}{τ} \qquad eq . 38$$

if the left rectangle rule is used.

### Process (22). Estimator of the Envelope of the Power Spectral Density of the Mucosal Wave Correlate.

The envelope of the power spectral density of the mucosal wave correlate is defined as the Fourier Transform module of a mucosal wave cycle, this being:

$${S}_{wk} ( m ) = \vert {\sum }_{n ∈ {N}_{k}}^{ } {s}_{wk} ( n ) {e}^{j \frac{2 π mn}{{N}_{k}}} \vert \qquad eq . 39$$

FIG. 8 shows an example of said estimation, with the main biometric parameters derived from the singularities of the envelope.

### Process (23). Estimator of the Biometric Parameters of the Glottal Wave: Cepstral Parameters and Singularities of the Envelope of the Power Spectral Density.

The definition of the set of biometric parameters of the glottal wave includes three types of parameters. The first set of parameters results from the evaluation of the cepstral coefficients of the mucosal wave correlate from cycle to cycle according to the following definition:

$${C}_{wk} ( q ) = \vert {\sum }_{m ∈ {W}_{k}}^{ } log ( {S}_{wk} ( m ) ) {e}^{j \frac{2 π mq}{{W}_{k}}} \vert \qquad eq . 40$$

where Wₖ is the size of the window defined in the domain of the frequency above the power spectral density of the mucosal wave correlate and q is the selection index of the corresponding cepstral parameter. The resulting parametric allocation is the following:

p₇ₖ=C_{wk}(1); p₈ₖ=C_{wk}(2); p₉ₖ=C_{wk}(3);

p₁₀ₖ=C_{wk}(4); p₁₁ₖ=C_{wk}(5); p₁₂ₖ=C_{wk}(6);

p₁₃ₖ=C_{wk}(7); p₁₄ₖ=C_{wk}(8); p₁₅ₖ=C_{wk}(9);

p₁₆ₖ=C_{wk}(10); p₁₇ₖ=C_{wk}(11); p₁₈ₖ=C_{wk}(12);

p₁₉ₖ=C_{wk}(13); p₂₀ₖ=C_{wk}(14); eq. 41

The second set of parameters results from the evaluation of the values of the singularities of the profile of the power spectral density of the mucosal wave correlate as defined in FIG. 8, which is expressed as:

$${p}_{21 k} = max \{ 20 {log}_{10} [ {S}_{wk} ( m ) ] \} ; \\ {p}_{22 k} = min \{ 20 {log}_{10} [ {S}_{wk} ( {M}_{1} < m < {M}_{2} ) ] \} - {p}_{21 k} ; \\ {p}_{23 k} = max \{ 20 {log}_{10} [ {S}_{wk} ( m > {M}_{1} ) ] \} - {p}_{21 k} ; \\ {p}_{24 k} = min \{ 20 {log}_{10} [ {S}_{wk} ( {M}_{2} < m < {M}_{3} ) ] \} - {p}_{21 k} ; \\ {p}_{25 k} = max \{ 20 {log}_{10} [ {S}_{wk} ( m > {M}_{2} ) ] \} - {p}_{21 k} ; \\ {p}_{26 k} = 20 {log}_{10} [ {S}_{wk} ( m = {N}_{k} / 2 ) ] - {p}_{21 k} ; \\ {p}_{27 k} = arg max \{ 20 {log}_{10} [ {S}_{wk} ( m ) ] \} ; \\ {p}_{28 k} = \frac{arg min \{ 20 {log}_{10} [ {S}_{wk} ( {M}_{1} < m < {M}_{2} ) ] \}}{{p}_{27 k}} ; \\ {p}_{29 k} = \frac{arg max \{ 20 {log}_{10} [ {S}_{wk} ( m > {M}_{1} ) ] \}}{{p}_{27 k}} ; \\ {p}_{30 k} = \frac{arg min \{ 20 {log}_{10} [ {S}_{wk} ( {M}_{2} < m < {M}_{3} ) ] \}}{{p}_{27 k}} ; \\ {p}_{31 k} = \frac{arg max \{ 20 {log}_{10} [ {S}_{wk} ( m > {M}_{2} ) ] \}}{{p}_{27 k}} ; \\ {p}_{32 k} = \frac{{N}_{k}}{2 {p}_{27 k}} ; \qquad eq . 42$$

where M₁, M₂ and M₃ are the arguments of the three first maximums of the power spectral density of the mucosal wave correlate expressed in decibels.

The third set of parameters includes the aspect ratios of the two first minimums of the profile of the power spectral density of the mucosal wave correlate, defined as:

$${p}_{33 k} = \frac{2 {S}_{wkdB} ( {m}_{1} ) - {S}_{wkdB} ( {M}_{1} ) - {S}_{wkdB} ( {M}_{2} )}{2 ( {M}_{2} - {M}_{1} )} ; \\ {p}_{34 k} = \frac{2 {S}_{wkdB} ( {m}_{2} ) - {S}_{wkdB} ( {M}_{2} ) - {S}_{wkdB} ( {M}_{3} )}{2 ( {M}_{3} - {M}_{2} )} \qquad eq . 43$$

where S_{wkdB} is the power spectral density referred to in decibels.

### Process (24). Estimator of the Biomechanical Parameters of the Body of the Vocal Folds.

Reliable estimations of the relative values of the elastic masses and tensions of the vocal folds may be obtained based on the power spectral density of the mean acoustic wave:

$${S}_{sk} ( m ) = \vert {\sum }_{n ∈ {N}_{k}}^{ } {s}_{sk} ( n ) {e}^{j \frac{2 π mn}{{N}_{k}}} \vert \qquad eq . 44$$

The estimation technique is based on the adaptive adjustment of the power spectral density of the mean acoustic wave against the transfer function of the vocal fold model of a mass. The working hypothesis is based on the assumption that the mean acoustic wave is determined by the dynamic components of the fold and therefore its power spectral density is directly related to the square modulus of the admittance of the electromechanical model of a mass given by:

$$\begin{matrix}{G}_{b} ( ω ) = \vert {Y}_{b} {\vert}^{2} \\ = \vert \frac{{{V}_{x} ( ω )}^{2}}{{F}_{x} ( ω )} {\vert}^{2} \\ = {[ {( ω {M}_{b} - {ω}^{- 1} {K}_{b} )}^{2} + {R}_{b}^{2} ]}^{- 1}\end{matrix} \\ {S}_{dk} ( m ) \approx {G}_{b} ( ω = m Ω ) ; \qquad eq . 45$$

where M_{b}, K_{b} and R_{b} are respectively the parameters associated with the dynamic mass, the elasticity and the losses of the model of a mass when only the body thereof is taken into consideration. The robust estimation of the parameters of the model is based on determining the two points above the power spectral density of the dynamic component such as {G_{b1}, ω₁} and {G_{b2}, ω₂}. The biomechanical parameters of the glottal source are estimated approximate to the power spectral density of the glottal source by means of the transfer function of an RLC series system whose circuit elements—M_{b}, K_{b} and R_{b}—are selected from the methods described hereinafter.
a. Estimation of the Loss Parameters
the loss parameter of the body is estimated as

$${R}_{b} = \frac{{F}_{b 0}}{\sqrt{{G}_{r}}} \qquad eq . 46$$

where Gᵣ is the value of the square modulus of the input admittance given by eq. 45 to the resonance frequency ωᵣ determined by the first maximum of the power spectral density of the glottal source.
b. Estimation of the Mass Parameter

The dynamic mass equivalent to the body of the cord may be estimated as:

$${M}_{b} = \frac{{ω}_{2}}{{ω}_{2}^{2} - {ω}_{1}^{2}} \sqrt{\frac{{G}_{b 1} - {G}_{b 2}}{{G}_{b 1} {G}_{b 2}}} \qquad eq . 47$$

The selection of the most suitable reference points {T_{b1}, ω₁} and {T_{b2}, ω₂} is closely related to the robustness of the estimation method.

c. Estimation of the Elasticity Parameter

Once the dynamic mass parameter has been determined, the elastic rigidity parameter K_{b} may be obtained from accurately determining the maximum peak {Tᵣ, ωᵣ}, as:

K_{b}=M_{b}ωᵣ² eq. 48

d. Imbalance of the Biometric Parameters

The vocal folds are asymmetric from an anatomical, physiological and biomechanical point of view, both in individuals who are normophonic (those classified as being without dysfunction by specialists in phoniatrics or speech therapy after examination and outlining their medical history) and dysphonic individuals (those who have been diagnosed with a specific change in phonation as a result of an organic or functional cause), although possibly to a greater extent with certain dysphonias than in others. This asymmetry may be viewed as an imbalance in the biomechanical parameters estimated for adjacent phonation cycles. This imbalance may be greater in cases where the physiological pathology of the vocal fold is present, especially if it affects both folds in a different manner as in the case of cysts or unilateral polyps, for example. The imbalance in the vibration of the vocal folds should correspond to an imbalance in the estimations of the biomechanical parameters of a given individual when compared cycle to cycle. It is generally accepted that the presence of imbalance is a correlate of the pathology of the vocal fold and that this imbalance is estimated in distortion parameters such as jitter and shimmer. The imbalance between adjacent phonation cycles may be seen in (42) and (49) as although originating from supposedly normophonic individuals, the difference in amplitude from cycle to cycle is recorded and even though it is less perceptible, also the difference in its duration. For all the aforementioned, it is of the utmost interest to collect the intercyclic variations of the estimations of the biomechanical parameters by means of measurements of the imbalance in mass. tension and losses obtained for each cycle (μ_{b}: Imbalance in the mass of the body; σ_{b}: Imbalance in the loss of the body; γ_{b}: Imbalance in the tension of the body), which may be defined as:

μ_{bk}=(\hat{M}_{bk}−\hat{M}_{bk-1})/(\hat{M}_{bk}+\hat{M}_{bk-1})

ρ_{bk}=(\hat{R}_{bk}−\hat{R}_{bk-1})/(\hat{R}_{bk}+\hat{R}_{bk-1})

γ_{bk}=(\hat{K}_{bk}−\hat{K}_{bk-1})/(\hat{K}_{bk}+\hat{K}_{bk-1}) eq. 49

where 1≦k≦K is the index of the phonation cycle and \hat{M}_{bk}, \hat{R}_{bk}, y \hat{K}_{bk} are the estimates for the mass, the losses and the tension for the k-th cycle of a voice sample originating from a given individual. Given that the inter-elasticity parameter K_{bl,r} is not included in the usual list of biomechanical parameters, if it is considered that the vocal folds are completely symmetrical, it may be sufficient to calculate three parameters per fold (mass, elasticity and loss of the body and same for the cover), and the three imbalances thereof, until having six biomechanical parameters of the body of the vocal fold. The parameter allocation table is as follows:

p₃₅ₖ=M_{bk}; p₃₆ₖ=R_{bk}; p₃₇ₖ=K_{bk};

p₃₈ₖ=μ_{bk}; p₃₉ₖ=ρ_{bk}; p₄₀ₖ=γ_{bk}; eq. 50

### Process (25). Estimator of the Biomechanical Parameters of the Cover of the Vocal Fold.

Similar to the case of the biomechanical parameters of the body of the vocal fold, the biomechanical parameters of the cover thereof are estimated based on the power spectral density of the mucosal wave correlate, calculated according to eq. 39 in a similar manner to that described in (24) with reference to the parameters of the body of the fold, by means of adjustment of the transfer function of a second order system whose circuit elements—M_{c}, K_{c} and R_{c}—are selected by way of the same method as in (24). For the biomechanical parameters of the cover of the vocal fold, similar derivations based on the mucosal wave correlate are used since the influence of the body of the cord has been eliminated when the mean acoustic wave is separated from the glottal source, reducing the problem to the model of a single mass, which facilitates application of the same methodology. With respect to the imbalance parameters (μ_{c}: imbalance of the mass of the cover; σ_{c}: imbalance of the losses of the cover; γ_{c}: imbalance of the rigidity of the cover), the estimation thereof is also identical. The allocation of the resulting parameters is as follows:

p₄₁ₖ=M_{ck}; p₄₂ₖ=R_{ck}; p₄₃ₖ=K_{ck};

p₄₄ₖ=μ_{ck}; p₄₅ₖ=ρ_{ck}; p₄₆ₖ=γ_{ck}; eq. 51

### Brief Description of the Usage of the Different Parameters

The usage of the different parameters evaluated by means of the estimation process referred to in FIG. 3 is as follows, without excluding other possibilities:

Parameter p₁ₖ. This is the period of the glottal cycle, inverse to the basic frequency. It serves, together with others, to distinguish the masculine voice from the feminine.

Parameter p₂ₖ. This is the jitter given in eq. 27. It serves, together with others, to detect instability in phonation and helps to characterize the dysphonia (use in detecting and grading dysphonia).

Parameter p₃ₖ. This is the amplitude shimmer given in eq. 28. It serves, together with others, to detect instability in phonation and helps to characterize the dysphonia (use in detection and grading of dysphonia).

Parameter p₄ₖ. This is the area shimmer given in eq. 29. It serves, together with others, to detect instability in the phonation and helps to characterize the dysphonia (use in detecting and grading dysphonia).

Parameter p₅ₖ. This is the sharpness of the glottal closure given in eq. 31. It serves, together with others, to detect emotion in phonation and helps to characterize the dysphonia (use in detecting and grading dysphonia).

Parameter p₆ₖ. This is the mucosal wave to glottal wave ratio given in eq. 32. It serves, together with others, to detect possible neurological changes in a speaker and helps to characterize the dysphonia (use in detecting and grading dysphonia).

Cepstral parameters p₇ₖ-p₂₀ₖ. They form part of the biometric signature of the speaker in a compact form according to eq. 41 and together with others, they help to identify and verify the speaker, both in secure access applications such as in forensic comparison.

Spectral profile parameters p₂₁ₖ-p₃₄ₖ. They form part of the biometric signature of the speaker according to eq. 42 and eq. 43 as well as the normophonic and dysphonic behavior of the latter, and together with others, they help to identify and verify the speaker (use in secure access or forensic comparison) and to determine the presence of dysphonia of organic origin (use in detecting and grading dysphonia).

Biomechanical parameters p₃₅ₖ-p₄₆ₖ. They constitute a robust set of descriptors for the mechanical functioning of the glottis according to eq. 50 and eq. 51 and together with others, they help to determine the possible causes of dysphonia and quantify the grade thereof (use in detecting and grading dysphonia).

Temporal base parameters p₄₇ₖ-p₅₈ₖ. They constitute a robust descriptor of the moments of interest in the glottal cycle (closure, return, opening) according to eq. 24 and together with others serve to characterize the dysphonia (use in detecting and grading dysphonia).

### POSSIBLE EXEMPLARY EMBODIMENTS OF THE INVENTION

### Embodiment 1

### System for the Parameterization of the Glottal Wave Correlates and the Clinical and Forensic Use Thereof in Advanced Studies of the Voice

The complete parameterization method is integrated via a platform similar to that in FIG. 1 without a general-purpose computer platform being excluded, which allows a speech segment of arbitrary duration to be registered, via which the expert (user) can position vocal segments for easy inspection, via which the parameters selected by the user in the settings are extracted. The interface allows the desired frame to be analyzed and its results compared against any other previously analyzed frame, against a normophonic speaker model for detecting and grading dysphonia, or against a universal speaker model for forensic comparison. The results may be seen in windows on the screen, displayed as individual windows, printed as .pdf documents or stored in an Excel® spreadsheet.

### Embodiment 2

### System for Monitoring and Evaluating the Phonation Efficacy by way of a Specialist Otorhinolaryngology Service

The partial parameterization method is integrated via a platform similar to that in FIG. 1 without a general purpose computer platform being excluded which registers a vocal segment /a/ of 0.2 seg. via which the parameters p₁ₖ-p₅₈ₖ are extracted and display the latter via a user interface including the standard ranges for said parameters with the aim that the doctor assesses the quality of phonation.

### Embodiment 3

### Application for Screening Patients in Primary Care Centers

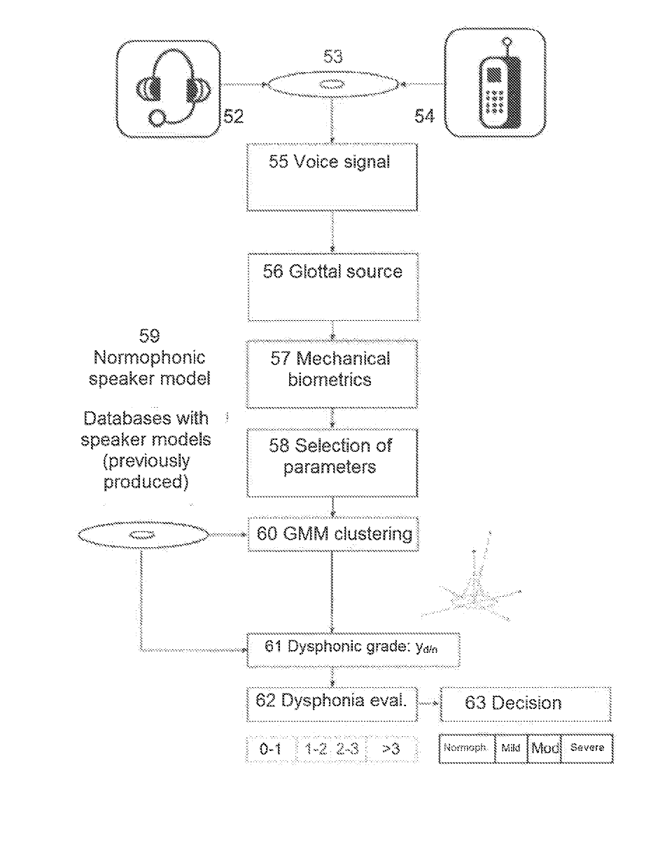

The parameterization method is integrated via a platform similar to that in FIG. 1 without a general purpose computer platform being excluded, or a type of portable mobile telephone device, PDA or iPod with a simple microphone which registers a voice segment and carries out various parameterizations on contiguous segments in the center of the captured frame, these representing a standard population (see FIG. 11) in the form of a traffic light according to the contrast of the segments on a standard population (see FIG. 11) in a user interface which is reduced such that the primary care medic may determine whether or not it is advisable to refer the patient to specialist services. This situation is complemented by generating an electronic document in .pdf format, a copy of which is sent to the ORL specialist service and another copy provided to the patient.

### INDUSTRIAL APPLICATION

### Application to Detect and Grade Dysphonia for Developing a Primary Care Model in the Pathology of the Voice.

This is set within the context of the relation between the primary care medical centers and the care services specializing in otorhinolaryngology. Detecting and grading dysphonia may be carried out in a very simple interface similar to that described in FIG. 1 (10), following the analysis method from FIG. 11. The parameters estimated based on the glottal source for a normophonic population previously evaluated by the ORL specialist services and stored in a database with the speaker models are used to construct a normophonic speaker model (59) for men and another for women, in an age range of 18-60 years. A voice recording (52, 54) carried out using the interface from FIG. 1 (11) is automatically contrasted with the normophonic speaker model (59), a contrast analysis of a set of parameters being obtained against the statistics of the normophonic speaker model (61). If the parameters evaluated for the subject being examined display outside the scope of normality, a traffic light is colored for each parameter (63). Using this visual information, the primary care medic may take the decision whether or not to refer the patient to the specialist primary care services for examination and treatment. This function is called “patient screening” and is intended to increase the efficiency of the specialist services, avoiding unnecessary examinations, saving costs and time for specialized personnel.

### Application to Indentify and Verify the Speaker for Secure Access to Systems and Installations.

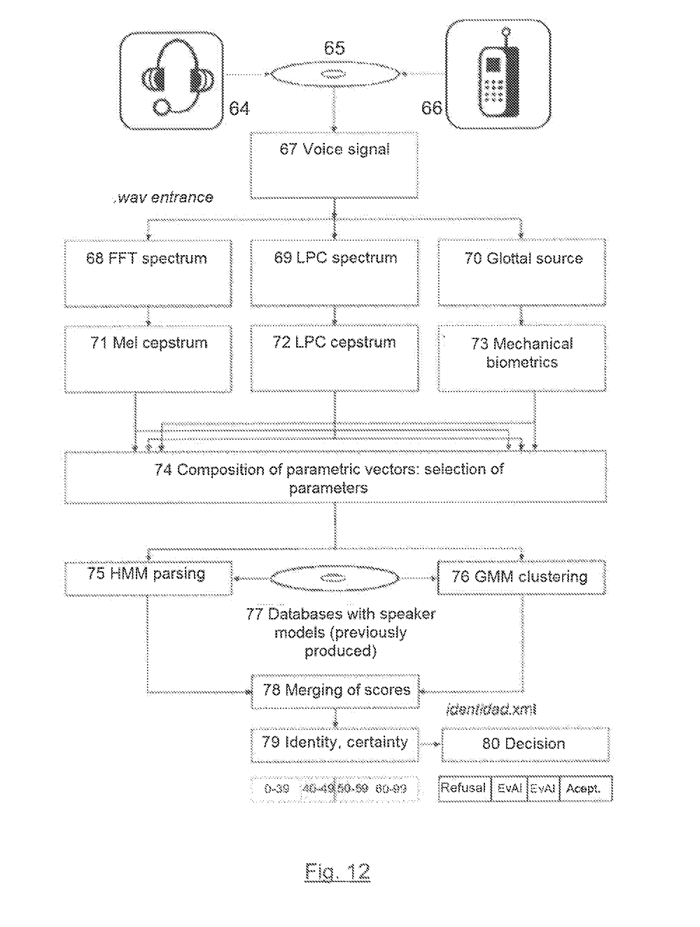

This application allows access rights to be granted or denied to individuals by means of their voice signature, by means of an interface such as that shown in FIG. 1 (10), following the methodological description provided in FIG. 12. In FIG. 12, based on the voice signal (64, 66), Fourier spectral parameters (FFT) and linear prediction parameters (LPC) are extracted which are used to detect the message generated by the speaker (e.g. their number or a pin) as well as to detect their biometric signature (68-73). The latter is mixed with the mechanical biometric signature obtained from the glottal source to produce a supervector (74), whose sequencing is analyzed to derive the message printed therein (75 parsing HMM) and it is biometrically contrasted in the database with the speaker models (76 clustering GMM). The values from the analysis are combined to give a scoring (78 score fusion) which is used to determine the identity of the speaker from a closed set (77) and provide a degree of certainty to said identity (79). Depending on these parameters, the decision is made whether to grant or deny access (80 acceptance, refusal) or request a re-evaluation of the voice or another multi-modal biometric system (alternative evaluation).

### Application to Verify and for Forensic Comparison to Evaluate Evidence.

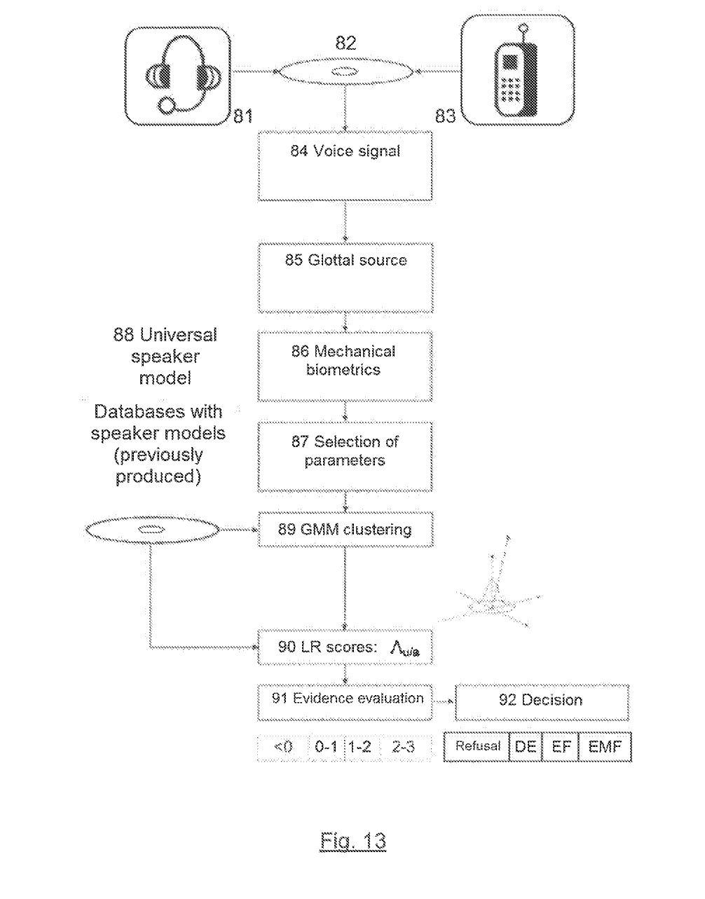

This application is based on the interface (10) in FIG. 1, according to which a pre-recorded voice (82) may be analyzed or a new voice recording (81, 83) recorded, which may be contrasted against a universal speaker model (88) previously generated (universal speaker model) according to the methodology presented in FIG. 13. The result of the evaluation (90 LR scores) is contrasted against a scale (91 evidence evaluation) which for values below 0, favors the defense hypothesis (that there is no plausible evidence to link the processed voice—dubitable—against another previously recorded voice whose identity is known—indubitable—with the guarantee of similarity or disparity thereof with respect to the universal speaker model provided by the database). 0 to 2 indicates weak evidence (ED) or strong evidence (EF), although the accusation hypothesis is not sufficiently confirmed (that there is plausible evidence of a link between dubitable and indubitable). In these cases, the in dubio pro reo principle is used. Lastly, if the evidence is above 2. the evidence is considered to be very strongly (EMF) in favor of the accusation hypothesis.

### Application to Detect Tremor in the Voice for Early Detection of Neurologic Pathology and the Emotional Burden of the Speaker.

This application is based on the same platform as that described in FIG. 11 for the application to detect and grade dysphonia, following the same methodological guidelines. The fundamental difference is that in order to generate the databases of speaker models (59) and to contrast the voice of the patient against the databases, only certain parameters of the entire set are taken into account, such as pₖ₅, pₖ₆, pₖ₇ and pₖ₈ together with pₖ₃₇ and pₖ₄₃, since it was possible to determine that these parameters, and not others, display a high correlation with the neurological deterioration of the speaker and the change of their emotional state according to studies previously carried out by the proponents of this application. The parameters to be configured for application of this method in primary care service centers, similar to those described in FIG. 1, will be those cited, the type of evaluation being similar to that in FIG. 11. The databases of speaker models will have been developed with the voice of individuals free of neurological and organic pathologies, previously selected in a ORL/neurological specialist service center. The method for evaluation and decision-making will, otherwise, be the same as for the organically originating dysphonia already mentioned. The value of the analysis will also be the value from evaluating the grade of neurological deterioration (non existent, mild, moderate or severe) with the aim of referring the patient to specialist services or otherwise.

1. A method for estimating the physiological parameters of phonation based on a voice signal comprising:
compensating for the radiation of the lips in the voice signal by means of canceling the first order pole generated by said radiation in the spectrum of the voice signal,
performing inverse filtering on at least one of the phonated segment in a phonation cycle for a compensated voice signal, wherein said inverse filtering in turn comprises:
modulating the spectral inversion of the compensated voice signal to extract the deglottalized voice signal,
modulating the spectral inversion of the vocal tract to extract the glottal wave without substantial influence of the vocal tract and to obtain the vibration correlates of the vocal folds.

2. The method according to claim 1, wherein the step of compensating for the radiation of the lips also comprises:
modulating the spectral inversion of the vocal tract by means of a plurality of adaptive lattice filters, which can also be chained together, said filters being configured to divide the voice signal into two signals via which the crossed correlation between the two dephased, divided signals is calculated, cancelling the effect of the radiation of the lips and generating a signal free of radiation.

3. The method according to claim 1, wherein the step of modulating the spectral inversion of the signal also comprises:
implementing a plurality of mirror model filters configured to estimate the partial correlation and eliminate said partial correlation of the glottal signal owing to the vocal tract generating new glottal signals without substantial influence of the vocal tract.

4. The method according to claim 1, wherein it comprises calculating the glottal wave s_{qi}(n) by means of integrating the residual signal of the glottal wave sᵣᵢ(n).

5. The method according to claim 4, comprising estimating at least one of the following temporal parameters via the glottal wave s_{qi}(n):
start of the glottal cycle;
recovery time Tr;
start time of the opening of the vocal cords To;
time of maximum supraglottal pressure Tm;
start time of the closure of the vocal folds Tc;
end time of the glottal cycle having minimum supraglottal pressure Tg;
coefficients ODQ, CDQ and GEQ.

6. The method according to claim 4, comprising estimating at least one of the following distortion parameters via the glottal wave s_{qi}(n):
jitter,
amplitude shimmer,
area shimmer,
sharpness of closure,
cover to body ratio.

7. The method according to claim 4, wherein it comprises estimating the mean acoustic wave v_{qi}(n) for estimating at least one of the following sets of biometric parameters via the glottal wave s_{qi}(n) by means of detecting the mean acoustic wave:
power spectral density of the mucosal wave correlate,
cepstral coefficients of the glottal correlate of the mucosal wave,
singularities of the envelope of the power spectral density of the glottal correlate of the mucosal wave.

8. The method according to claim 4, wherein it comprises estimating the mean acoustic wave v_{qi}(n) for at least one of the following biomechanical parameters via the glottal wave s_{qi}(n) by means of detecting the mean acoustic wave:
loss parameter,
dynamic mass parameter equivalent to the body of the cord,
elasticity parameter,
imbalances between the phonation cycles with respect to:
the dynamic mass of the body,
the losses of the body,
the elasticity of the body.

9. A system for estimating the physiological parameters of phonation based on a voice signal which comprises:
means configured to compensate for the radiation of the lips in the voice signal by means of canceling the first order pole generated by said radiation in the spectrum of the voice signal,
means configured to perform inverse filtering on at least one of the phonated segments in a phonation cycle for a compensated voice signal, wherein said inverse filtering in turn comprises:
means configured to modulate the spectral inversion of the compensated voice signal to extract the deglottalized voice signal,
means configured to modulate the spectral inversion of the vocal tract to extract the glottal wave without substantial influence of the vocal tract and to obtain the vibration correlates of the vocal folds.

10. The system according to claim 9, wherein the means configured to compensate for the radiation of the lips also comprise:
means configured to modulate the spectral inversion of the vocal tract, in turn comprising a plurality of adaptive lattice filters, which can also be chained together, wherein said filters are configured to divide the voice signal into two signals via which the crossed correlation between the two dephased, divided signals is calculated, cancelling the effect of the radiation of the lips and generating a signal free of radiation

11. The system according to claim 9, wherein the means configured to modulate the spectral inversion of a signal also comprise:
a plurality of mirror model filters configured to estimate the partial correlation due to the vocal tract and eliminate said partial correlation from the glottal signal.

12. The system according to claim 9, wherein the estimations are carried out via at least one normophonic speaker model and are stored in a number of storage means to be compared with the estimations of a speaker in order to determine the presence and grade of dysphonia in accordance with the deviation present between both estimations.

13. The system according to claim 9, wherein the estimations of any speaker are stored in a number of storage means to unequivocally identify said speaker.
